(19) United States
(12) Patent Application Publication
(10) Pub. No.: US 2018/0127043 A1
(43) Pub. Date: May 10, 2018

(54) BICYCLE COVER SYSTEMS

(71) Applicants: Christopher Edwards, Brooklyn, NY (US); Christian Mekongo, Brooklyn, NY (US)

(72) Inventors: Christopher Edwards, Brooklyn, NY (US); Christian Mekongo, Brooklyn, NY (US)

(21) Appl. No.: 15/345,403

(22) Filed: Nov. 7, 2016

(51) Int. Cl. B62J 19/00

(52) U.S. Cl. CPC B62J 19/00; E05B 71/00

(57) ABSTRACT

A bicycle cover system for providing a protective cover having drawstrings, at least one aperture, and chain slots for protecting a bicycle from vandalism and weather damage while parked on streets. The device is able to cover a bicycle and includes chain slots that allow a user to lock one's bike to a stationary item with the protective cover intact. The device further includes drawstrings for tightening the cover around the frame of a bicycle.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of protective covers and more specifically relates to bicycle cover systems.

### 2. Description of Related Art

A bicycle, often called a bike or cycle, is a human-powered, pedal-driven, single-track vehicle, having two wheels attached to a frame, one behind the other. A bicycle rider is called a cyclist, or bicyclist. Often times when riding a bicycle, a rider must leave the bicycle in a designated spot. Riders usually lock the bicycle to a fixed object to prevent theft. At times a rider may need to leave the bike locked up for extended periods of time. Vandalism and weathering may occur. A suitable solution is desired.

Several attempts have been made to solve the above-mentioned problems such as those found in U.S. Pat. No. 6,040,764 to Frances Crisci; U.S. Pat. No. 5,372,169 to Merritt Norton; and U.S. Pat. No. 8,893,900 to Alon Kedar. This art is representative of protective covers. However, none of the above inventions and patents, taken either singly or in combination, is seen to describe the invention as claimed.

Preferably, a protective cover should provide a protective covering for a bicycle having chain slots allowing a user to lock the bicycle and protect the bicycle from vandalism and weathering and, yet would operate reliably and be manufactured at a modest expense. Thus, a need exists for a reliable bicycle cover system to avoid the above-mentioned problems.

### BRIEF SUMMARY OF THE INVENTION

In view of the foregoing disadvantages inherent in the known protective cover art, the present invention provides a novel protective cover. The general purpose of the present invention, which will be described subsequently in greater detail is to provide a bicycle cover system.

A bicycle cover system is disclosed in a preferred embodiment herein comprising a bicycle cover assembly including a cover having an inner surface, and an outer surface, drawstrings, at least one aperture, and at least one chain slot.

The bicycle cover system comprises the bicycle cover assembly. The bicycle cover assembly comprises the cover, the drawstrings, the at least one aperture, and the at least one chain slot in functional combination. The cover comprises the inner surface and the outer surface. The inner surface is adjacent a bicycle during use. The outer surface provides a protection layer.

The cover comprises a flexible body. The cover comprises stop tare. The cover further comprises a zipping fastener. The zipping fastener is located at the rear of the wheel of the bicycle. The zipping fastener comprises a pull tab. The cover when used forms a wedged profile to cut wind. The cover forms a front-apex adjacent a front the wheel of the bicycle. The cover forms a rear-apex adjacent a rear the wheel of the bicycle. The cover is pulled taunt over handlebars of the bicycle.

The drawstrings are used to contour the cover around the bicycle in a weather resistant contour. The drawstrings pass through the at least one aperture and the drawstrings are able to freely move through the aperture in relation to the cover such that the cover can be contoured to the bicycle and to contourly-repel the environmental conditions. The drawstrings are useable to tighten the cover adjacent wheels of the bicycle. The drawstrings further comprise cordlocks. The at least one chain slot is structured and arranged to receive at least one securer. The at least one securer comprises a chain for securing the bicycle. The chain slots are pierced through the cover and located adjacent a frame of the bicycle on respective sides allowing for securing the bicycle via the securer. The cover comprises a plurality of chain slots permitting the bicycle to be locked from various points. The chain slots comprise overlaying flaps to prevent moisture intrusion. The bicycle cover assembly is useful for protecting the bicycle from vandalism and weather damage while parked on streets.

The present invention holds significant improvements and serves as a bicycle cover system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, bicycle cover systems, constructed and operative according to the teachings of the present invention.

FIG. 1 shows a perspective view illustrating a bicycle cover system comprising a bicycle cover assembly during an ‘in-use’ condition showing a bicycle enclosed within a cover having drawstrings, at least one aperture, and chain slots according to an embodiment of the present invention.

FIG. 2 is a perspective view illustrating the bicycle cover assembly comprising the cover having the drawstrings, at least one aperture and the chain slots according to an embodiment of the present invention of FIG. 1.

FIG. 3 is a perspective view illustrating the cover according to an embodiment of the present invention.

FIG. 4 is a perspective view illustrating the bicycle cover assembly according to an embodiment of the present invention.

The various embodiments of the present invention will hereinafter be described in conjunction with the appended drawings, wherein like designations denote like elements.

### DETAILED DESCRIPTION

As discussed above, embodiments of the present invention relate to a protective cover and more particularly to a bicycle cover system as used to improve the protection of a bicycle while locked up in a public location.

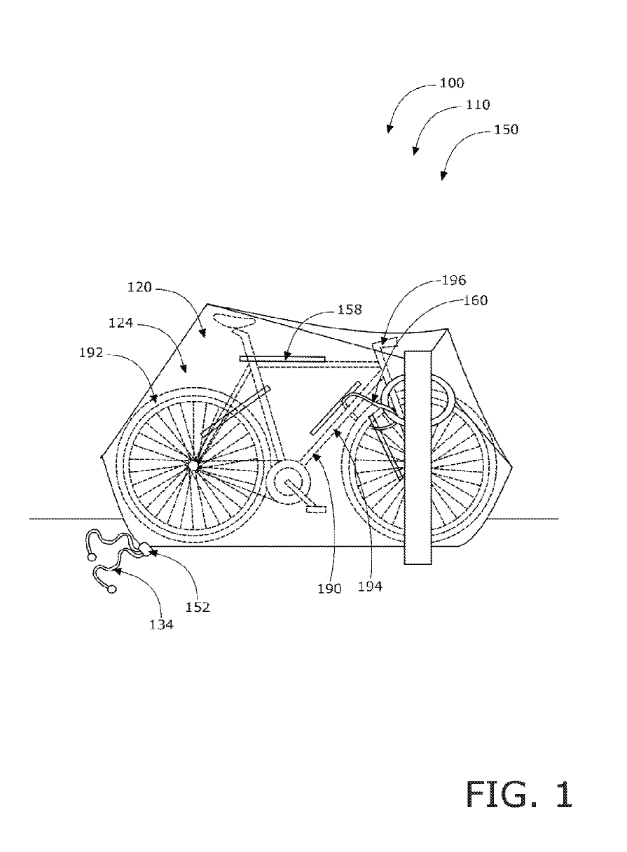

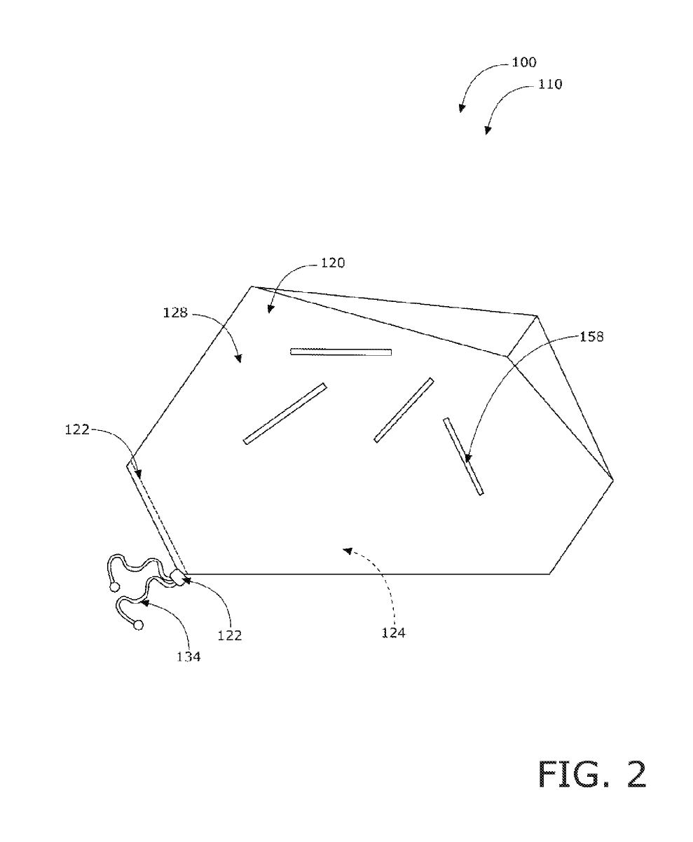

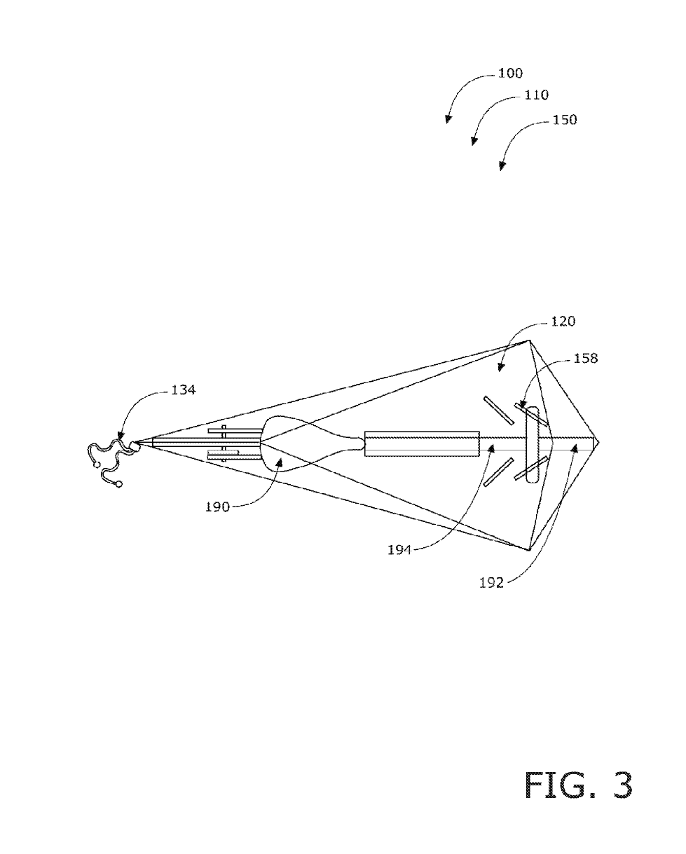

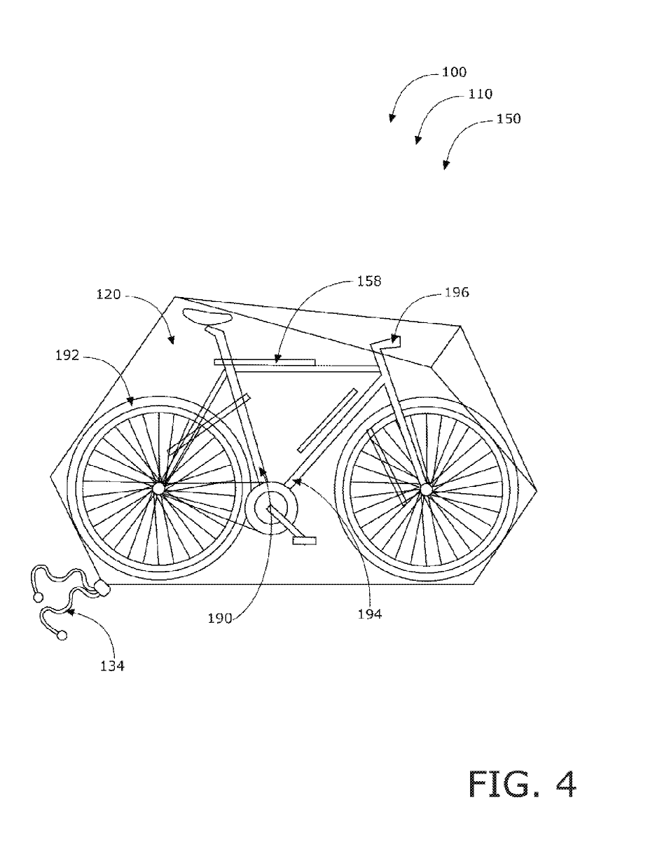

Referring to the drawings by numerals of reference there is shown in FIGS. 1-4, bicycle cover system 100 according to an embodiment of the present invention. Bicycle cover systems 100 may comprise bicycle cover assembly 110, which may comprise cover 120 having inner surface 124, and outer surface 128, drawstrings 134, at least one aperture 152, and at least one chain slot 158.

Bicycle cover system 100 comprises bicycle cover assembly 110. Bicycle cover assembly 110 comprises cover 120 having inner surface 124, and outer surface 128, drawstrings 134, at least one aperture 152, and at least one chain slot 158 in functional combination. Cover comprises inner surface 124, and outer surface 128. Inner surface 124 is adjacent bicycle 190 during use. Outer surface 128 provides a protection layer.

Drawstrings 134 are used to contour cover 120 around bicycle 190 in a weather resistant contour. Drawstrings 134 pass through at least one aperture 152 and drawstrings 134 are able to freely move through aperture 152 in relation to cover 120 such that cover 120 can be contoured to bicycle 190 and to contourly-repel the environmental conditions. At least one chain slot 158 is structured and arranged to receive at least one securer 160.

Cover 120 comprises a flexible body. Cover 120 may comprise stop tare. Cover 120 further comprises zipping fastener 122. Cover 120 when used forms a wedged profile to cut wind. At least one securer 160 may comprise a chain for securing bicycle 190. At least one securer 160 comprises a cable for securing bicycle 190. Drawstrings 134 are useable to tighten cover 120 adjacent wheels of bicycle 190. Cover 120 forms a front-apex adjacent a front of wheel 192 of the bicycle. Cover 120 forms a rear-apex adjacent a rear of wheel 192 of bicycle 190. Zipping fastener is located at the rear of the wheel of the bicycle 190.

Chain slots 158 are pierced through cover 120 and located adjacent frame 194 of bicycle 190 on respective sides allowing for securing bicycle 190 via securer 160. Cover 120 comprises a plurality of chain slots 158 permitting bicycle 190 to be locked from various points. Cover 120 is pulled taunt over handlebars 196 of the bicycle 190. Drawstrings 134 further comprise cordlocks. Zipping fastener 122 comprises a pull tab. Chain slots 158 comprise overlaying flaps to prevent moisture intrusion. As such, bicycle cover assembly 110 is useful for protecting bicycle 190 from vandalism and weather damage while parked on streets. Bicycle cover systems 100 may be manufactured and provided for sale in a wide variety of sizes and shapes for a wide assortment of applications.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A bicycle cover system comprising:
a bicycle cover assembly including;
a cover having;
an inner surface; and
an outer surface;
drawstrings;
at least one aperture; and
at least one chain slot;
wherein said bicycle cover system comprises said bicycle cover assembly;
wherein said bicycle cover assembly comprises said cover, said drawstrings, said at least one aperture, and said at least one chain slot in functional combination;
wherein said cover comprises said inner surface and said outer surface;
wherein said inner surface is adjacent a bicycle during use;
wherein said outer surface provides a protection layer;
wherein said drawstrings are used to contour said cover around said bicycle in a weather resistant contour;
wherein said drawstrings pass through said at least one aperture and said drawstrings are able to freely move through said aperture in relation to said cover such that said cover can be contoured to said bicycle and to contourly-repel said environmental conditions;
wherein said at least one chain slot is structured and arranged to receive at least one securer; and
wherein said bicycle cover assembly is useful for protecting said bicycle from vandalism and weather damage while parked on streets.

2. The bicycle cover system of claim 1 wherein said cover comprises a flexible body.

3. The bicycle cover system of claim 1 wherein said cover comprises stop tare.

4. The bicycle cover system of claim 1 wherein said cover further comprises a zipping fastener.

5. The bicycle cover system of claim 1 wherein said cover when used forms a wedged profile to cut wind.

6. The bicycle cover system of claim 1 wherein said at least one securer comprises a chain for securing said bicycle.

7. The bicycle cover system of claim 1 wherein said at least one securer comprises a cable for securing said bicycle

8. The bicycle cover system of claim 4 wherein said drawstrings are useable to tighten said cover adjacent wheels of said bicycle.

9. The bicycle cover system of claim 8 wherein said cover forms a front-apex adjacent a front said wheel of said bicycle.

10. The bicycle cover system of claim 8 wherein said cover forms a rear-apex adjacent a rear said wheel of said bicycle.

11. The bicycle cover system of claim 8 wherein said zipping fastener is located at said rear of said wheel of said bicycle.

12. The bicycle cover system of claim 1 wherein said chain slots are pierced through said cover and located adjacent a frame of said bicycle on respective sides allowing for securing said bicycle via said securer.

13. The bicycle cover system of claim 1 wherein said cover comprises a plurality of chain slots permitting said bicycle to be locked from various points.

14. The bicycle cover system of claim 1 wherein said cover is pulled taunt over handlebars of said bicycle.

15. The bicycle cover system of claim 1 wherein said drawstrings further comprise cordlocks.

16. The bicycle cover system of claim 1 wherein said zipping fastener comprises a pull tab.

17. The bicycle cover system of claim 1 wherein said chain slots comprise overlaying flaps to prevent moisture intrusion.

18. A bicycle cover system comprising:
a bicycle cover assembly including;
a cover having;
an inner surface; and
an outer surface;
drawstrings;
at least one aperture; and
at least one chain slot;
wherein said bicycle cover system comprises said bicycle cover assembly;
wherein said bicycle cover assembly comprises said cover, said drawstrings, said at least one aperture, and said at least one chain slot in functional combination;
wherein said cover comprises said inner surface and said outer surface;
wherein said inner surface is adjacent a bicycle during use;
wherein said outer surface provides a protection layer;
wherein said cover comprises a flexible body;
wherein said cover comprises stop tare;
wherein said cover further comprises a zipping fastener;
wherein said zipping fastener is located at said rear of said wheel of said bicycle;
wherein said zipping fastener comprises a pull tab;
wherein said cover when used forms a wedged profile to cut wind;
wherein said cover forms a front-apex adjacent a front said wheel of said bicycle;
wherein said cover forms a rear-apex adjacent a rear said wheel of said bicycle;
wherein said cover is pulled taunt over handlebars of said bicycle;
wherein said drawstrings are used to contour said cover around said bicycle in a weather resistant contour;
wherein said drawstrings pass through said at least one aperture and said drawstrings are able to freely move through said aperture in relation to said cover such that said cover can be contoured to said bicycle and to contourly-repel said environmental conditions;
wherein said drawstrings are useable to tighten said cover adjacent wheels of said bicycle;
wherein said drawstrings further comprise cordlocks;
wherein said at least one chain slot is structured and arranged to receive at least one securer;
wherein said at least one securer comprises a chain for securing said bicycle;
wherein said chain slots are pierced through said cover and located adjacent a frame of said bicycle on respective sides allowing for securing said bicycle via said securer;
wherein said cover comprises a plurality of chain slots permitting said bicycle to be locked from various points;
wherein said chain slots comprise overlaying flaps to prevent moisture intrusion; and
wherein said bicycle cover assembly is useful for protecting said bicycle from vandalism and weather damage while parked on streets.
